(19) United States
(12) Patent Application Publication
(10) Pub. No.: US 2014/0229433 A1
(43) Pub. Date: Aug. 14, 2014

(54) HOME APPLIANCE INFORMATION ACCUMULATION SERVER

(71) Applicant: Aplix IP Holdings Corporation, Tokyo (JP)

(72) Inventors: Daisuke Nakajima, Tokyo (JP); Soshi Akiyama, Tokyo (JP)

(73) Assignee: Aplix IP Holdings Corporation, Tokyo (JP)

(21) Appl. No.: 14/255,310

(22) Filed: Apr. 17, 2014

Related U.S. Application Data
(63) Continuation of application No. PCT/JP2012/076942, filed on Oct. 18, 2012.

(30) Foreign Application Priority Data
Oct. 18, 2011 (JP) 2011-228667

(51) Int. Cl. G06F 17/30

(52) U.S. Cl. CPC G06F 17/30289; G06F 17/30578
USPC 707/613; 707/609

(57) ABSTRACT

A home appliance information accumulation server according to the invention includes a communication unit, a storage unit, a database generation unit, and a database saving unit. The communication unit receives output data of a home appliance and identification information of an adapter which are transmitted from the adapter connected to the home appliance and capable of wireless communication. The storage unit accumulates the output data of the home appliance using the identification information of the adapter as a tag. The database generation unit generates or updates a database based on the data accumulated in the storage unit. The database saving unit saves the database generated or updated by the database generation unit.

### CROSS-REFERENCE TO RELATED APPLICATIONS

This is a Continuation application of PCT Application No. PCT/JP2012/076942, filed Oct. 18, 2012, which was published under PCT Article 21(2) in Japanese.

This application is based upon and claims the benefit of priority from the prior Japanese Patent Application No. 2011-228667, filed Oct. 18, 2011, the entire contents of which are incorporated herein by reference.

### BACKGROUND OF THE INVENTION

1. Field of the Invention

The present invention relates to a home appliance information accumulation server that accumulates information about home appliances.

2. Description of the Related Art

Studies have conventionally been conducted for monitoring/controlling home electrical appliances (to also be abbreviated as home appliances hereinafter) using a network technology, and various specifications and architectures have been proposed. For example, the ECHONET standard defines a specification for connecting various devices such as home appliances and sensors to a home network by converting communication protocols used by them and concentratedly monitoring/controlling the devices using a controller provided in a home, and also performing communication with an external network using the controller as a gateway (for example, see Jpn. Patent No. 3929733 or Jpn. Patent No. 4578258).

In the DLNA specification that is a technique taking a similar position home appliances in a home are connected to each other according to a communication procedure based on UPnP, thereby implementing a function of causing them to share content data or remote-control each other. Note that home appliances can also share various kinds of signals using CEC of the HDMI standards that handle video signals, audio signals, and control signals all at once. This configuration is implemented between devices of some makers but mainly only in a limited case where, for example, a recorder and a TV are connected.

On the other hand, some TVs or HDD recorders are connected to the Internet via a broadband router to receive a moving image distribution service from a moving image distribution service server on the Internet.

There are also implemented watching services in which the use state of an electric pot or gas in an elderly person's home is registered in a server, and the family living apart from him/her is notified of the use state by mail or browses it on a terminal to know that the pot or gas is being used, thereby monitoring the elderly person's life.

### BRIEF SUMMARY OF THE INVENTION

A home appliance information accumulation server according to the invention includes a communication unit, a storage unit, a database generation unit, and a database saving unit. The communication unit receives output data of a home appliance and identification information of an adapter which are transmitted from the adapter connected to the home appliance and capable of wireless communication. The storage unit accumulates the output data of the home appliance using the identification information of the adapter as a tag. The database generation unit generates or updates a database based on the data accumulated in the storage unit. The database saving unit saves the database generated or updated by the database generation unit.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing an example of an information service system using a home appliance information accumulation server;

FIG. 2 is a functional block diagram of the home appliance information accumulation server;

FIG. 3 is a schematic view showing the form of information saved in a storage unit;

FIG. 4 is a table showing an example of data output from home appliances;

FIG. 5 shows the table definitions of databases for respective product types in which (a) indicates an example of a table definition for a health meter, (b) indicates that for an HDD recorder, (c) indicates that for a TV, (d) indicates that for a pot, and (e) indicates that for an air conditioner;

FIG. 6 is a functional block diagram of a service server;

FIG. 7 is a flowchart showing the procedure and contents of an operation of accumulating information output from a home appliance in the home appliance information accumulation server; and

FIG. 8 is a flowchart showing the procedure and contents of an operation of causing a terminal device to receive a service based on information output from a home appliance.

### DETAILED DESCRIPTION OF THE INVENTION

Hereinafter, embodiments of this invention will be described with reference to the drawings.

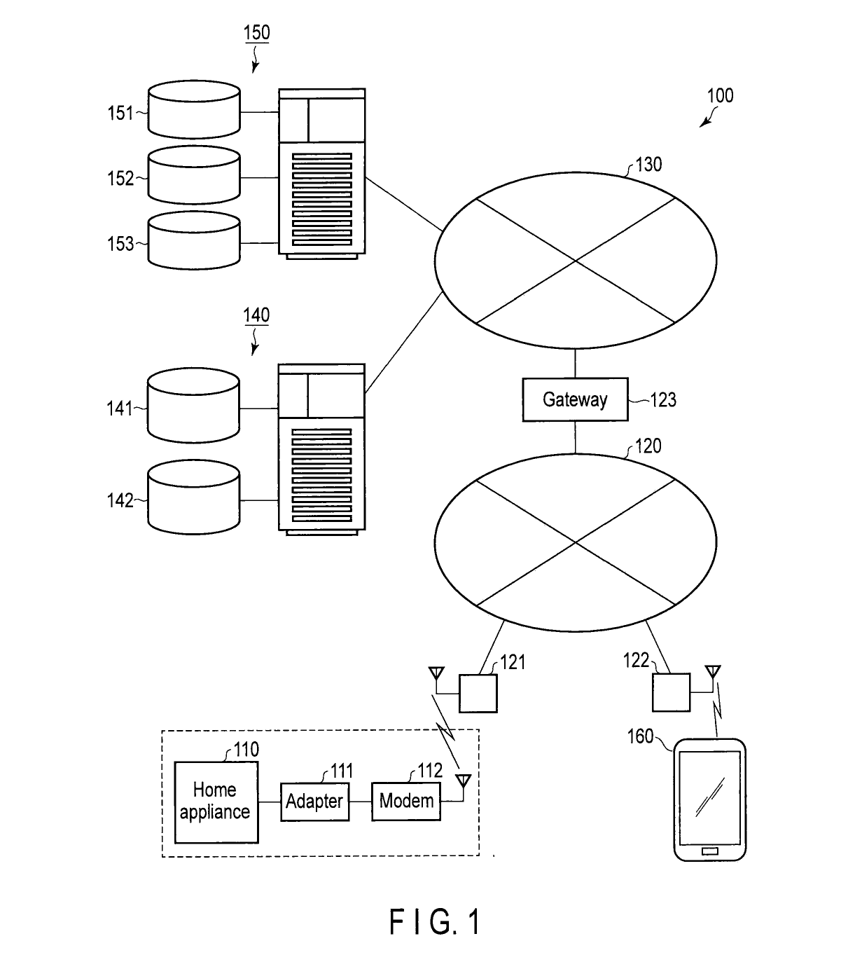

FIG. 1 is a view showing an information service system using a home appliance information accumulation server according to an embodiment. This information service system accumulates data of operation histories, manipulation histories, measurement results, local device states, and the like output from various kinds of home appliances in a home appliance information accumulation server, and causes a service server to offer a predetermined information service to a terminal device using the accumulated data.

As shown in FIG. 1, an information service system 100 mainly makes devices in a home including a home appliance 110 connectable to a home appliance information accumulation server 140 and a service server 150 via a mobile communication network 120 and the Internet 130. Each component will be described below in detail.

The type of the home appliance 110 is not limited, and can be any of white goods such as a refrigerator, cleaner, dish washer, washing machine, air conditioner, and various kinds of lighting equipment and cookware (for example, rice cooker, microwave oven, and electric pot), audiovisual equipment such as an HDD recorder and a TV, beauty care equipment, and health appliances. However, the home appliance 110 has not only its function as a home appliance but also an additional function of outputting data representing its operation history, manipulation history, measurement result, local device state, and the like. A modem 112 is connected, via an adapter 111, to an interface for outputting the data.

The adapter 111 incorporates a microcontroller including a CPU (Central Processing Unit) and a memory. The data output interface of the home appliance 110 and the interface of the modem 112 are connected to the microcontroller. The memory of the microcontroller is formed from a ROM or a flash ROM and a RAM. The ROM or flash ROM stores a device driver configured to control the modem 112, a protocol stack configured to implement communication by the TCP\IP protocol, an RTOS that manages a resource and provides basic functions, and a main control program configured to implement a communication sequence (to be described later) using these programs. The RAM of the microcontroller serves as a heap area, a stack area, or the like when executing various programs. The CPU of the microcontroller executes the various programs stored in the ROM using the RAM, thereby implementing a predetermined function.

The modem 112 is wirelessly connected to the mobile communication network 120 via a base station 121 or 122 based on a control signal input from the adapter 111, and provides a communication function to the adapter 111

The main control program of the adapter 111 will be described here in more detail. Various kinds of information such as the ID character string of the adapter 111, a product type to which the home appliance 110 belongs, a data format to be output from the home appliance 110, and an address, port number, login ID character string, and password necessary to log in to the home appliance information accumulation server 140 (to be described later) are embedded in the main control program. The main control program controls the modem 112 using the device driver, thereby connecting the adapter 111 to the mobile communication network 120 (to be described later) and logging in to the home appliance information accumulation server 140 using the protocol stack and various kinds of information. The main control program thus implements a function of adding necessary information to data output from the home appliance 110 and transmitting it. In this embodiment, data is transmitted after the ID character string of the adapter 111, the product type to which the home appliance 110 belongs, and the data format to be output from the home appliance 110 are added as tag information.

As described above, in this embodiment, the adapter 111 and the modem 112, which provide the communication function to the home appliance 110, are externally provided, and the adapter 111 controls the modem 112 to perform communication. For this reason, the home appliance 110 need not additionally incorporate hardware and software for communication. Hence, when the function of outputting data of an operation history, manipulation history, measurement result, local device state, and the like from an input/output interface is added to an existing home appliance, it can be applied to the information service system according to this embodiment.

However, externally providing the adapter 111 and the modem 112, as shown in FIG. 1, is not essential. Components corresponding to them may be incorporated in the home appliance 110. Alternatively, instead of providing the adapter 111, the control unit of the home appliance 110 may implement the communication function.

The mobile communication network 120 is a network that implements mobile communication by a predetermined wireless communication method, and provides a data communication function by packet switching to the modem 112 and a terminal device 160 (to be described later) as well as a speech communication function by circuit switching. The mobile communication network 120 is provided with the plurality of base stations 121 and 122. The modem 112 and the terminal device 160 are wirelessly connected to the base stations 121 and 122. The mobile communication network 120 and the Internet 130 are connected via a gateway 123. The modem 112 and the terminal device 160 can be connected to the mobile communication network 120 via the base stations 121 and 122 and perform communication by packet switching. The modem 112 and the terminal device 160 can also be connected to the Internet 130 via the gateway 123 and transmit/receive data to/from the home appliance information accumulation server 140 and the service server 150 (to be described later).

The Internet 130 is a set of computer networks communicably connected by an Internet protocol. Innumerable server computers and terminals are connected to the Internet. Data and programs are exchanged between them so that various kinds of services such as web, mail, FTP, and file sharing are implemented and widely used. As a recent practice, a server system for offering a service is virtually constructed using a plurality of server computers by a cloud computing technology.

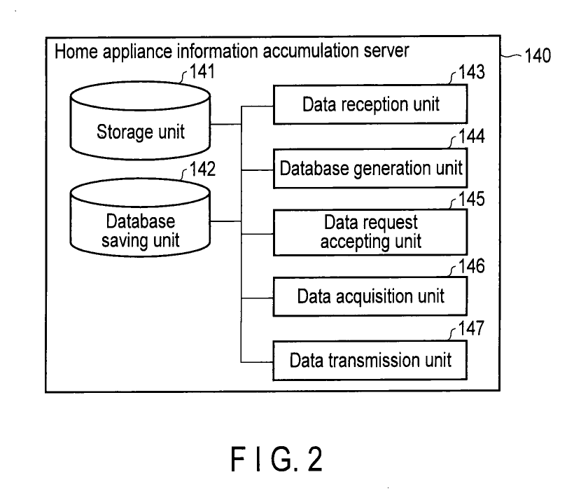

The home appliance information accumulation server 140 is a server system connected to the Internet 130, and can be either formed by implementing a service program on a server computer or virtually constructed by the cloud computing technology. FIG. 2 is a functional block diagram of the home appliance information accumulation server 140 according to this embodiment. As shown in FIG. 2, the home appliance information accumulation server 140 mainly includes a storage unit 141, a database saving unit 142, a data reception unit 143, a database generation unit 144, a data request accepting unit 145, a data acquisition unit 146, and a data transmission unit 147.

The data reception unit 143 receives a login request from the adapter 111, performs authentication by a password, and receives output data of the home appliance 110, which is transmitted from the adapter 111 whose authenticity has been confirmed. The output data of the home appliance 110 received by the data reception unit 143 is directly saved in the storage unit 141. The data saved in the storage unit 141 is managed by tags (adapter ID and product type) added to the data by the adapter ill.

More specifically, data output from the home appliance 110 connected to a specific adapter 111 can be extracted using the adapter ID tag. In addition, data output from the home appliance 110 associated with a specific product type can be extracted using the product type tag.

The database generation unit 144 has a function of extracting data associated with a specific adapter ID, a specific data format, or a specific product type from the storage unit 141, generating a database in accordance with a predetermined table definition, and saving it in the database saving unit 142. If a database is already generated and saved in the database saving unit 142, the database is updated from the saved database and data additionally saved in the storage unit 141.

The table definition of the database to be generated by the database generation unit 144 is defined for each data format or product type. Data of a new data format or product type can be coped with by adding a table definition. The arrangement of the database to be generated can additionally be changed by exchanging the table definition. The database saving unit 142 saves the database generated or updated by the database generation unit 144 in a state referable from the data acquisition unit 146.

The data request accepting unit 145 authenticates a login request transmitted from the service server 150 (to be described later), and accepts a data request from the service server 150 whose authenticity has been confirmed. Upon accepting the data request from the service server 150, the data request accepting unit 145 calls the data acquisition unit 146 and also transfers information of data to be acquired.

The data acquisition unit 146 specifies a database to extract data from the database saving unit 142 based on the information of data to be acquired, which is transferred from the data request accepting unit 145, extracts the data to be acquired, and transfers it to the data transmission unit 147. The data transmission unit 147 transmits the data acquired by the data acquisition unit 146 to the service server 150.

As described above, the home appliance information accumulation server 140 according to this embodiment saves data output from the home appliance 110 directly in the storage unit 141. It is therefore possible to directly accumulate data of various operation histories, manipulation histories, measurement results, local device states, and the like output from a variety of home appliances. It is therefore unnecessary, on the side of the home appliance 110, to comply with the data format supported by the server, and a service can freely be designed.

On the other hand, the home appliance information accumulation server 140 generates a database based on data output from the home appliance 110 for each of the adapter ID, product type, and/or data format, and holds it. Hence, upon receiving a data request from an external server, a response to the request can quickly be returned by reading out data from the database with excellent search and reference properties.

The storage unit 141 saves data output from the home appliance 110 as primary information. Hence, to change/add the format of the database after the start of a service, the table definition of the database is changed/added, and a new database is then generated. This makes it possible to easily cope with the change/addition of the database.

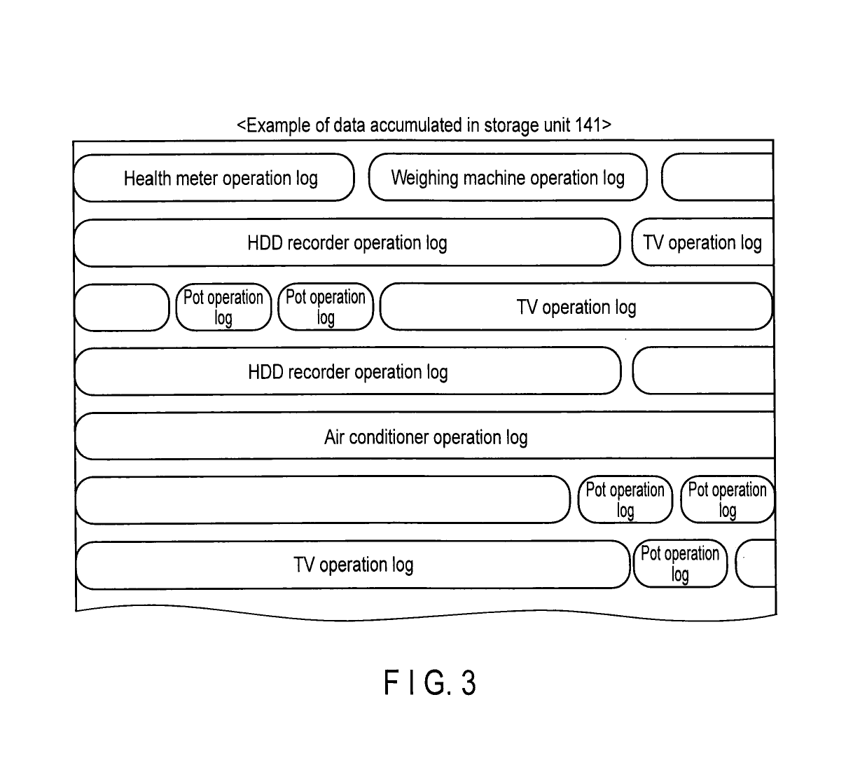

FIG. 3 is a view showing a state in which the storage unit 141 accumulates data output from various kinds of home appliances. The rounded rectangles in FIG. 3 indicate the operation logs of a health meter, HDD recorder, pot, TV, and air conditioner. The size of a rectangle corresponds to the size of data. The data are stored in the order of reception by the home appliance information accumulation server 140. FIG. 3 shows a state in which the data are accumulated in the order of a health meter operation log, weighing machine operation log, HDD recorder operation log, TV operation log, pot operation log, . . . .

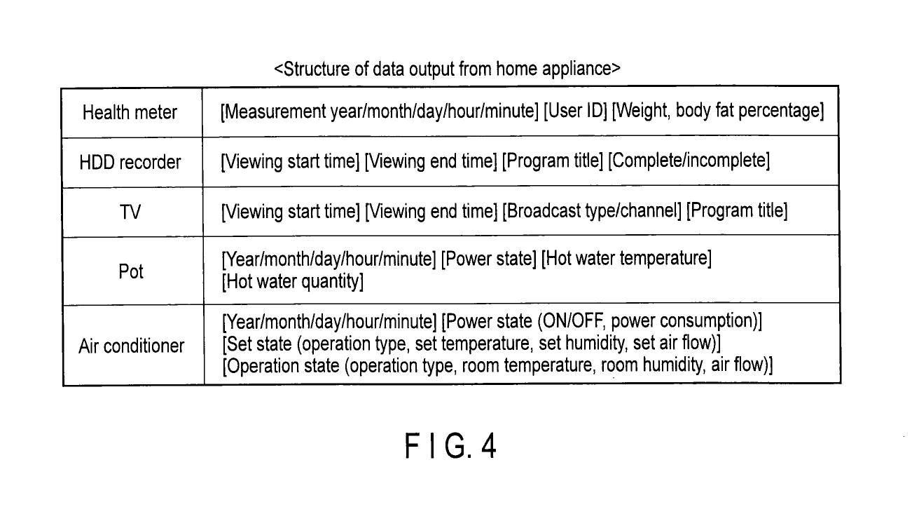

FIG. 4 is a table showing the structures of the data output from the home appliances shown in FIG. 3. The output data of each home appliance can be formed from, for example, hexadecimal data of elements shown in FIG. 4. As shown in FIG. 3, the storage unit 141 stores the data of various kinds of home appliances in a mixed state.

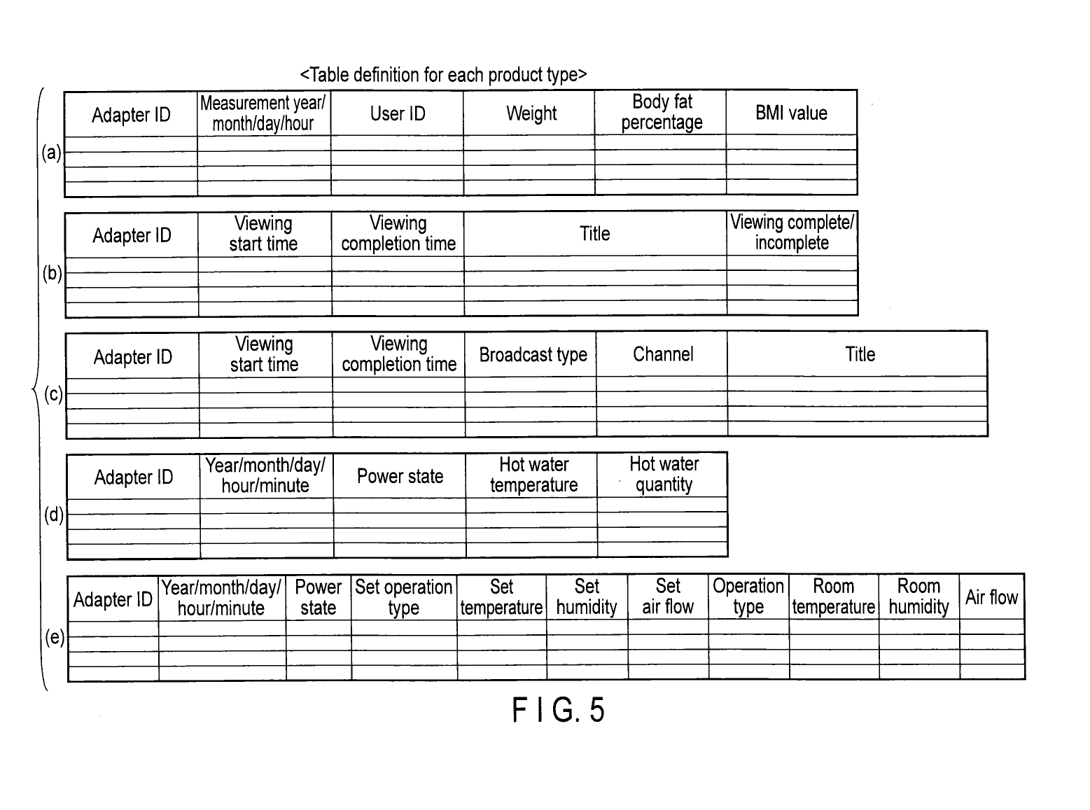

FIG. 5 shows, for respective product types, the table definitions of databases generated by the database generation unit 144 from the data stored in the storage unit 141 in the above-described way in which (a) indicates an example of a table definition for a health meter, (b) indicates that for an HDD recorder, (c) indicates that for a TV, (d) indicates that for a pot, and (e) indicates that for an air conditioner. The data acquisition unit 146 extracts requested data from the database for each product type. Note that although the databases for the respective product types are shown here, almost the same table definitions can be used even for databases for not the product types but the respective data formats output from the home appliance 110. When generating databases for the respective adapter IDs, the databases can be generated using table definitions corresponding to the product types or the data formats.

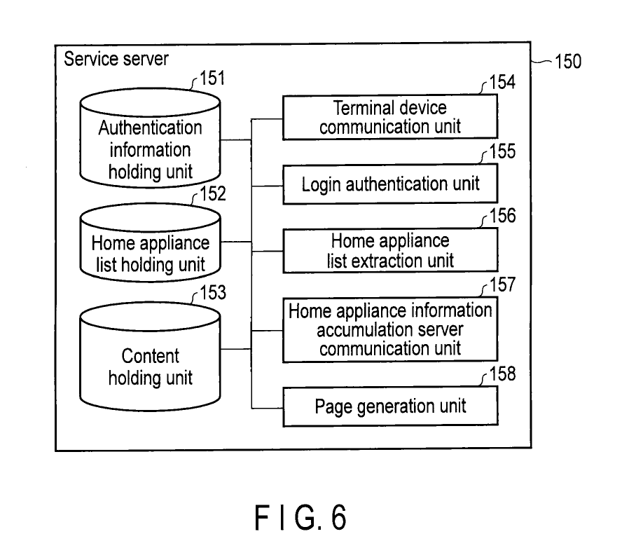

The service server 150 is a server that offers an information service to the terminal device 160 based on the data accumulated in the home appliance information accumulation server 140. The service server 150 according to this embodiment is configured to generate web pages based on the accumulated data. FIG. 6 is a functional block diagram of the service server 150 according to this embodiment.

As shown in FIG. 6, the service server 150 mainly includes an authentication information holding unit 151, a home appliance list holding unit 152, a content holding unit 153, a terminal device communication unit 154, a login authentication unit 155, a home appliance list extraction unit 156, a home appliance information accumulation server communication unit 157, and a page generation unit 158.

The terminal device communication unit 154 is configured to perform communication with the terminal device 160 (to be described later) via the Internet 130 and the mobile communication network 120. The terminal device communication unit 154 accepts access from the terminal device 160 and transmits/receives information. When the terminal device communication unit 154 receives a login request from the terminal device 160, the login authentication unit 155 collates the service ID and password associated with the login request with contents saved in the authentication information holding unit 151, thereby performing authentication.

When the terminal device 160 that has logged in to the service server 140 requests a home appliance list, the home appliance list extraction unit 156 acquires a list saved in the authentication information holding unit 151 and transmits it to the terminal device 160 via the terminal device communication unit 154.

The home appliance information accumulation server communication unit 157 communicates with the home appliance information accumulation server 140 and transmits/receives information in response to a request from the terminal device 160 or asynchronously.

The page generation unit 158 generates, using contents held by the content holding unit 153, a page screen to be transmitted to the terminal device 160 based on information that the home appliance information accumulation server communication unit 157 has acquired from the home appliance information accumulation server 140. The page screen generated by the page generation unit 158 is transmitted to the terminal device 160 via the terminal device communication unit 154 and displayed on the display of the terminal device 160.

The authentication information holding unit 151 registers and holds a service ID and password for each user who receives the service. The home appliance list holding unit 152 holds the list of home appliances registered by the user who receives the service together with the adapter ID. The content holding unit 153 holds contents to be used as the elements of a page when it is generated by the page generation unit 158.

With the above-described arrangement, the service server 150 executes a service of generating a page screen based on information accumulated in the home appliance information accumulation server 140 and distributing it to the terminal device 160. For example, when a health meter is used as the home appliance 110, the service server can offer a service of creating a graph using data of the user's weight, body fat percentage, and the like accumulated in the home appliance information accumulation server 140 and displaying it. The service server may offer a service of separately receiving a management target for a weight and the like from the user and graphically displaying the degree of difference from the target. In addition, the service server may offer a service of calculating a degree of obesity or the like from data of the user's weight, body fat percentage, and the like and accordingly displaying a message for health management and/or a service of distributing advertisements of supplements, health appliances, fitness clubs, insurance, and the like according to the user's condition together.

When an HDD recorder or a TV is used as the home appliance 110, the service server can offer a service of classifying viewed titles by genre and listing them based on the information of the viewed titles of the user accumulated in the home appliance information accumulation server 140. The service server can also offer a service of creating a list of web sites or SNS communities including the impressions and reviews of titles viewed by the user and a list of SNS users who viewed the same titles and distributing the lists.

The service server may also analyze the tendency of programs liked by the user based on the information of titles viewed by him/her and distribute advertisements of broadcast or on-demand distribution of other titles included in the tendency, and sales, rental, and the like of DVDs and other associated goods of the titles. If data of other users can be acquired from the home appliance information accumulation server 140 and used, unviewed titles may be extracted from the viewed titles of other users who viewed the same program and recommended to the user.

When a pot is used as the home appliance 110, a service similar to the existing watching services can be formed using the operation history of the pot accumulated in the home appliance information accumulation server 140. When a hot water quantity value is accumulated as shown in FIGS. 4 and 5, the physical condition of the pot user can be monitored by monitoring the consumed hot water quantity per day.

When an air conditioner is used as the home appliance 110, it is possible to form a service of graphically displaying the daily operation history together with the actually measured value of the room temperature based on the history of air conditioner operation/preset accumulated in the home appliance information accumulation server 140. In this case, the service server 150 may be made communicable with an external information providing server so as to form a service of acquiring temperature information from a server that provides weather information and judging whether the operation history or preset contents in the home appliance information accumulation server 140 are uneconomical or not.

As described above, the home appliance information accumulation server 140 can accumulate data transmitted from a plurality of home appliances 110. The information service system 100 can include a plurality of home appliance information accumulation servers 140 and a plurality of service servers 150. The plurality of service servers 150 may transmit/receive information to/from the plurality of home appliance information accumulation servers 140 and offer services to the user. The home appliance information accumulation server 140 and the service server 150 may virtually be constructed on a server group including a plurality of servers by the cloud computing technology.

The terminal device 160 has a function of connecting with the mobile communication network 120 and communicating, by packet communication, with the service server 150 connected to the Internet 130 via the gateway 123. The terminal device 160 displays information received from the service server 150 on the display and provides it to the user, or receives a user operation as an input. As the terminal device 160, a mobile communication terminal such as a feature phone, a smartphone, or a tablet terminal can be used.

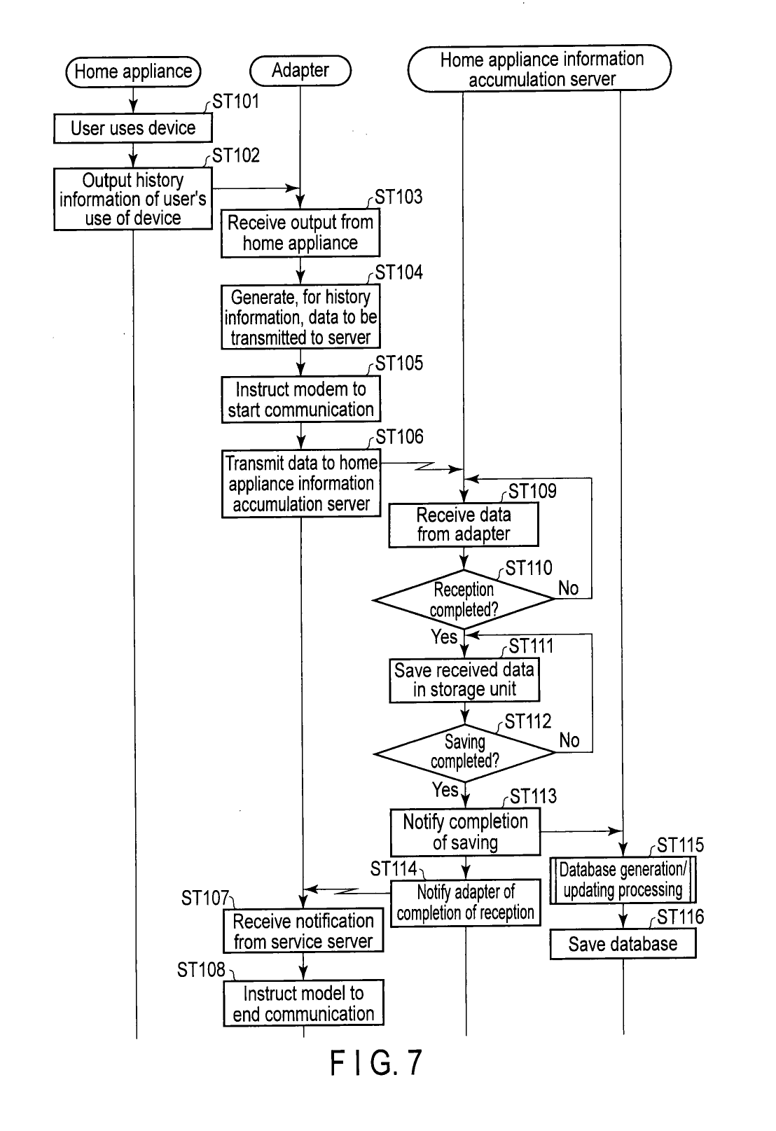

An operation performed when information output from the home appliance 100 is accumulated in the home appliance information accumulation server 140 via the adapter 111 in the information service system 100 having the above-described arrangement will be described below with reference to the sequence chart of FIG. 7.

This operation starts when the user uses the home appliance 110 (step ST101). Triggered by the user's use, the home appliance 110 outputs history information of the user's use of the home appliance to the adapter 111 (step ST102). Note that although user's use has been exemplified here as a trigger, when the home appliance 110 incorporates a timer, history information may be output periodically using the timer.

The adapter 111 receives the history information output from the home appliance 110 (step ST103). Based on the history information output from the home appliance 110, the adapter 111 generates data to be transmitted to the home appliance information accumulation server 140 (step ST104). In this case, for example, the adapter ID assigned to the adapter 111, the output data format, and/or the product type of the home appliance 110 is added as tag information to the output data of the home appliance 110 having the structure shown in FIG. 4, thereby generating data to be transmitted to the home appliance information accumulation server 140.

The adapter 111 transmits a command to the modem 112 using the device driver and instructs it to start communication (step ST105). When instructed to start communication, the modem 112 connects with the mobile communication network 120 via the base station 121 in a packet communication mode. Next, the adapter 111 transmits the data generated in step ST104 to the home appliance information accumulation server 140 using the modem 112. At this time, the adapter 111 performs communication using the IP protocol with the home appliance information accumulation server 140 via the gateway 123 using the protocol stack of the microcontroller.

Upon receiving the data transmitted from the adapter 111, the home appliance information accumulation server 140 parallelly executes a first task where steps ST109 to ST114 are performed and a second task where steps ST115 and ST116 are performed, thereby performing the following operation.

First, in the first task, the data reception unit 143 receives the data transmitted from the adapter 111 (step ST109), and determines whether reception is completed (step ST110). Upon determining that reception is not completed, reception continues.

On the other hand, upon determining in step ST110 that reception is completed, the received data is saved in the storage unit 141 (step ST111). The data saved at this time is the data output from the home appliance 110. The adapter ID, data format, and/or product type added by the adapter 111 is used as a tag to manage the data. That is, when the adapter ID or the product type of the home appliance 110 is designated, data associated with the adapter ID or product type saved in the storage unit 141 can be accessed.

Subsequently, it is determined whether data saving is completed (step Set112). If data saving is not completed, data saving continues. On the other hand, if data saving is completed, the second task is notified of the completion of saving (step ST113).

In the second task that is notified of the completion of saving by the first task, the database generation unit 144 generates or updates a database associated with the received data (step ST114). The updated database is saved in the database saving unit 142 (step ST115).

With the above-described operation, the data output from the home appliance 110 is accumulated and saved in the storage unit 141 of the home appliance information accumulation server 140 in a state of a database that can easily be accessed from the outside.

On the other hand, after notifying the second task of the completion of saving, the first task notifies the adapter 111 of the completion of reception (step ST114). Upon receiving the notification, the adapter 111 is notified of the completion of communication by the home appliance information accumulation server 140 (step ST107), and issues a command to instruct the modem 112 to complete communication (step ST108). Accordingly, the modem 112 completes communication with the mobile communication network.

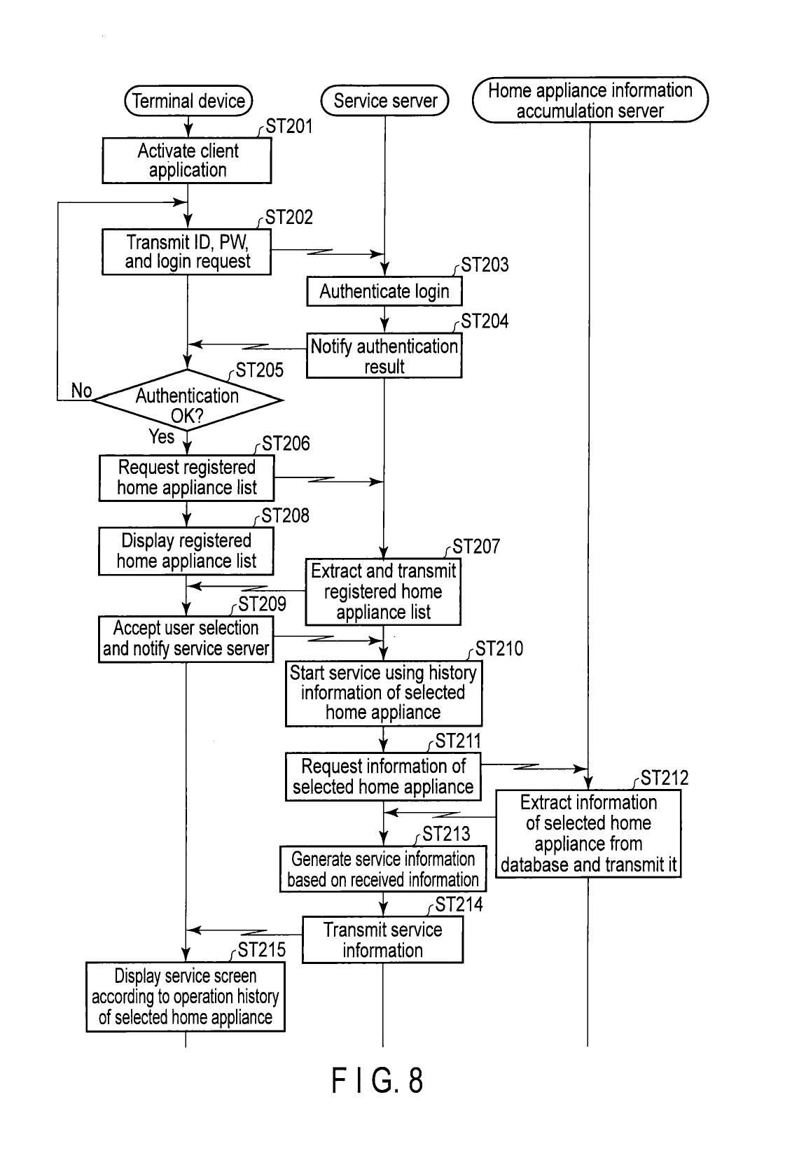

An operation of the service server 150 for providing service information to the terminal device 160 based on data accumulated in the home appliance information accumulation server 140 in the information service system 100 will be described next with reference to the sequence chart of FIG. 8.

This operation starts when a client application (in this embodiment, a browser) is activated on the terminal device 160 (step ST201). The activated client application transmits an ID and password and sends a login request to the service server 150 (step ST202).

Upon receiving the login request from the terminal device 160, the service server 150 causes the login authentication unit 155 to collate the ID and password transmitted from the terminal device 160 with those held by the authentication information holding unit 151 to perform login authentication (step ST203), and notifies the terminal device 160 of the authentication result (step ST204). When the authenticity of the terminal device 160 is confirmed, the service server 150 permits login of the terminal device 160. When the authenticity is not confirmed, the service server 150 rejects login of the terminal device 160.

If the authenticity of the local device 160 is not confirmed by the service server 150, terminal device 160 returns to step St202, requests re-input of the ID and password, and sends the login request to the service server 150 again. On the other hand, when the authenticity of the terminal device 160 is confirmed by the service server 150, the terminal device 160 requests a registered home appliance list from the service server 150 (step ST206). The registered home appliance list is a list of home appliances that the user of the terminal device 160 has registered in the service server 150 to receive a service using information accumulated in the home appliance information accumulation server 140, and is saved in the home appliance list holding unit 152 for each ID of the terminal device 160.

In response to the request from the terminal device 160, the service server 150 causes the home appliance list extraction unit 156 to acquire the registered home appliance list using the ID of the terminal device 160 of the request source as a key, and causes the terminal device communication unit 154 to transmit the list to the terminal device 160 (step ST207). Upon receiving the registered home appliance list, the terminal device 160 displays the list on the display (step ST208), and also forms a UI configured to select a home appliance as the target of an information service from the list and provides it to the user for selection.

Note that in this embodiment, a home appliance is selected from the home appliance list, thereby selecting a service using output data of the home appliance. However, a desired service may be selected from an information service list. In this case, the service server 150 holds a list of services usable by the terminal device 160 and transmits it to the terminal device 150. The terminal device 160 displays the list to form a UI and provides it to the user for selection.

Upon receiving a user operation of selecting a home appliance from the home appliance list, the terminal device 160 notifies the service server 150 of the selected home appliance (step ST209). When the terminal device communication unit 154 receives this notification, the service server 150 starts the service using the history information of the selected home appliance (step ST210).

The service server 150 that has started the service first causes the home appliance information accumulation server communication unit 157 to request information of the selected home appliance from the home appliance information accumulation server 140 by designating a corresponding adapter ID (step ST211).

When the data request accepting unit 145 receives the request, the home appliance information accumulation server 140 causes the data acquisition unit 146 to acquire data corresponding to the selected home appliance from the database saved in the database saving unit 142, and causes the data transmission unit 147 to transmit the data to the service server 160 (step ST212). At this time, the home appliance information accumulation server 140 need not transmit the whole database to the service server 150 and may transmit only data designated by the service server 150. Alternatively, data accumulated after the previous transmission may be transmitted.

When the home appliance information accumulation server communication unit 157 receives the data from the home appliance information accumulation server 140, the service server 150 causes the page generation unit 158 to generate, based on the received data, an HTML page associated with a screen to be displayed on the display of the terminal device 160 (step ST214), and causes the terminal device communication unit 154 to transmit the HMTL page to the terminal device 160 (step ST215). Upon receiving the HTML page from the service server, the terminal device 160 causes the client application to render the HTML page and display it on the display, and offers the information service based on the history information of the home appliance to the user (step ST215).

Hence, according to this embodiment, since the home appliance information accumulation server 140 directly saves received data in the storage unit 141 without limiting its format, data having various structures output from the home appliances 110 can directly be accumulated. In addition, since the home appliance information accumulation server 140 notifies the adapter 111 of the end of communication when the data output from the home appliance 110 is saved in the storage unit 141, the side of the home appliance 110 can quickly be released from the communication processing. Furthermore, the home appliance information accumulation server 140 saves the data output from the home appliance 110 in the storage unit 141, generates or updates a database after that, and responds to a data request from the service server 150 using the generated or updated database. For this reason, the home appliance information accumulation server 140 can respond to the data request from the service server 150 in a short response time.

That is, it is possible to provide a home appliance information accumulation server capable of easily accumulating data about the states and/or the operation histories and the like of various home appliances connected to a network and when data about a specific home appliance is requested, responding to the request in a short processing time. Hence, according to the present invention, it is possible to implement a general-purpose service platform of excellent performance using a server that accumulates information of home appliances.

The present invention is not limited to the above-described embodiment, and various changes and modifications can be made. For example, not the modem 112 but a wired or wireless LAN module may be connected to the adapter 111, and the adapter 111 may be connected to not the mobile communication network 120 but a public LAN. The structures of data output from the home appliances 110 and the data format of the databases saved in the home appliance information accumulation server 140 are not limited to those shown in FIGS. 4 and 5. In this embodiment, database generation or updating is triggered by saving data output from the home appliance 110 in the storage unit 141. Such processing may also periodically be performed using a timer.

Data transmitted from the service server 150 to the terminal device 160 is not limited to HTML data, and XML data or dedicated data to be displayed by a dedicated client application may be transmitted. In this case, a client application corresponding to the data is installed in the terminal device 160 and used.

Furthermore, the database generated by the home appliance information accumulation server 140 based on the data output from the home appliance 110 may include numerical values that have undergone predetermined statistical processing. For example, an average value of data accumulated concerning home appliances belonging to the same product type, a numerical value configured to evaluate the degree of difference between the data of each home appliance and the average value, and the like may be obtained as elements of a database.

In the above-described embodiment, the adapter 111 is connected to the mobile communication network 120 via the modem 112. However, the adapter 111 may be connected to the mobile communication network 120 via a terminal device. In this case, the adapter 111 and the terminal device can be connected by short distance wireless communication, infrared communication, NFC, or the like.

Although not particularly limited in the above embodiment, when the adapter 111 adds a data format tag to data output from the home appliance 110, and the home appliance information accumulation server 140 interprets the data based on the data format tag and generates a database based on a table definition corresponding to the data format, data output from the home appliance 110 is not limited by the product type, and a service of higher degree of freedom can be formed.

When the adapter 111 grasps the data format of data output from the home appliance and adds a data format tag corresponding to the data format, a single home appliance can output data of different data formats in accordance with the state and the like. The adapter 111 may add a data format tag corresponding to a separately grasped state of a home appliance or the like. The data format tag to be added by the adapter 111 can also be changed by transmitting a control signal or program from the network side to the adapter 111. Such a data format tag can be used together with or in place of a product type tag.

While several embodiments have so far been described in detail with reference to the drawings, this invention is not limited to the embodiments described above, and covers all embodiments carried out without departing from the spirit of the invention.

### [Addition]

The present inventors made various examinations assuming that when data of states, operation histories, and the like of home appliances are accumulated in a server on the Internet and made usable from an application on a terminal or an external web server, a variety of services can be implemented using the states and operation histories of the home appliances. The present inventors consequently obtained findings that the following requirements need to be met to implement a general-purpose service platform using a server for accumulating information of home appliances.

(1) Data can be Accumulated Independently of its Format

Since home appliances can assume various states and also output various kinds of information as operation histories, the formats of data including them cannot uniquely be determined. For this reason, to allow the server to accumulate data from various home appliances, data output from the home appliances are preferably directly accumulated, instead of defining the data format to be accumulated on the server side.

(2) Communication with a Home Appliance is Completed in a Short Time

When communication processing takes a long time, neither new communication nor operation can be done in the meantime. Since it is not preferable for a home appliance, communication between the server and the home appliance is preferably completed in a short time.

(3) Quick Response can be Returned to an External Data Request

A long response time to a request from an application or an external web server deteriorates the quality of a service. Hence, a quick response is preferable.

The present invention has been made focusing on the above-described points, and has the following means to achieve the object.

According to the first aspect, a home appliance information accumulation server comprises a communication unit configured to receive data output from a home appliance, a storage unit configured to accumulate the data received by the communication unit, a database generation unit configured to generate or update a database based on the data accumulated in the storage unit in accordance with a predefined table format, and a database saving unit configured to save the database generated by the database generation unit.

In the above-described arrangement, when the received data is saved in the storage unit, the communication unit preferably ends the communication with the home appliance. After the received data is saved in the storage unit, the database generation unit preferably performs the generation or updating processing of the database asynchronously to the communication unit. The home appliance information accumulation server preferably further comprises a data acquisition unit configured to, in response to an external data request, extract data from the database saved in the database saving unit and respond.

When an adapter or a modem is connected to the home appliance, the communication unit can be configured to communicate with the adapter and the modem so as to receive data output from the home appliance. In this case, the communication unit can be configured to receive an identification signal of the adapter together with the data output from the home appliance. The storage unit can be configured to manage the data output from the home appliance using the identification signal as a tag. The database generation unit can be configured to generate the database for each identification signal based on the data saved in the storage unit.

In addition, the communication unit can be configured to receive an identification signal associated with a data format output from the home appliance or an identification signal associated with the product type of the home appliance. In this case, the storage unit can be configured to manage the data output from the home appliance using the identification signal associated with the data format or the identification signal associated with the product type as a tag. The database generation unit can be configured to generate the database for each identification signal associated with the data format or identification signal associated with the product type in accordance with a table format corresponding to the identification signal.

The home appliance information accumulation server of the present invention accumulates data about the states and/or the operation histories and the like of home appliances connected to a network and holds a database generated by extracting data to be used by an external server for each device. It is therefore possible to provide the accumulated data to the external server in a readily usable state.

That is, the home appliance information accumulation server of the present invention saves data transmitted from the home appliance and/or a communication adapter connected to the home appliance directly in the storage unit. Hence, the data about the states and/or the operation histories and the like of a variety of home appliances connected to the network can be accumulated and saved independently of the format. At this time, since the received data is saved without processing such as conversion, database saving can quickly be ended. When the notification is transmitted to the home appliance or the like, communication processing can be ended in a short time.

However, the data saved in the storage unit includes raw data transmitted from various home appliances in a mixed state. If data extraction is performed after a data request for a specific device is received from an external server or the like, data extraction processing may take a time, and the response may considerably deteriorate.

To prevent this, in the home appliance information accumulation server according to the present invention, the database generation unit generates a database from data saved in the storage unit in advance and saves it in the database saving unit. This makes it possible to acquire data from the database with excellent search properties when a data request is received from an external server or the like. Since data need not be extracted from the whole storage unit, the response time is shortened, and a general-purpose service platform of excellent performance can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A home appliance information accumulation server comprising:
a communication unit configured to receive output data of a home appliance and identification information of an adapter which are transmitted from the adapter connected to the home appliance and capable of wireless communication;
a storage unit configured to accumulate the output data of the home appliance using the identification information of the adapter as a tag;
a database generation unit configured to generate or update a database based on the data accumulated in the storage unit; and
a database saving unit configured to save the database generated or updated by the database generation unit.

2. The home appliance information accumulation server according to claim 1, wherein the communication unit ends communication with the home appliance when the received data is saved in the storage unit.

3. The home appliance information accumulation server according to claim 1, wherein the database generation unit performs generation or updating processing of the database asynchronously to the communication unit after the received data is saved in the storage unit.

4. The home appliance information accumulation server according to claim 1, further including a data acquisition unit configured to, in response to an external data request, extract the data from the database saved in the database saving unit and respond.

5. A home appliance information accumulation server comprising:
a communication unit configured to receive output data of a home appliance and identification information of an adapter which are transmitted from the adapter connected to the home appliance and capable of wireless communication;
a storage unit configured to accumulate the output data of the home appliance;
a database generation unit configured to generate or update a database for each identification information of the adapter based on the data accumulated in the storage unit; and
a database saving unit configured to save the database generated or updated by the database generation unit.

6. The home appliance information accumulation server according to claim 5, wherein the communication unit ends communication with the home appliance when the received data is saved in the storage unit.

7. The home appliance information accumulation server according to claim 5, wherein the database generation unit performs generation or updating processing of the database asynchronously to the communication unit after the received data is saved in the storage unit.

8. The home appliance information accumulation server according to claim 5, further including a data acquisition unit configured to, in response to an external data request, extract the data from the database saved in the database saving unit and respond.

9. A home appliance information accumulation server comprising:
a communication unit configured to receive output data of a home appliance and one of identification information associated with a data format of the output data of the home appliance and identification information associated with a product type of the home appliance which are transmitted from an adapter connected to the home appliance and capable of wireless communication;
a storage unit configured to accumulate the output data of the home appliance using one of the identification information associated with the data format and the identification information associated with the product type as a tag;
a database generation unit configured to generate or update a database based on the data accumulated in the storage unit; and
a database saving unit configured to save the database generated or updated by the database generation unit.

10. The home appliance information accumulation server according to claim 9, wherein the communication unit ends communication with the home appliance when the received data is saved in the storage unit.

11. The home appliance information accumulation server according to claim 9, wherein the database generation unit performs generation or updating processing of the database asynchronously to the communication unit after the received data is saved in the storage unit.

12. The home appliance information accumulation server according to claim 9, further including a data acquisition unit configured to, in response to an external data request, extract the data from the database saved in the database saving unit and respond.

13. A home appliance information accumulation server comprising:
a communication unit configured to receive output data of a home appliance and one of identification information associated with a data format of the output data of the home appliance and identification information associated with a product type of the home appliance which are transmitted from an adapter connected to the home appliance and capable of wireless communication;
a storage unit configured to accumulate the output data of the home appliance;
a database generation unit configured to generate or update a database for one of each identification information associated with the data format and each identification information associated with the product type based on the data accumulated in the storage unit; and
a database saving unit configured to save the database generated or updated by the database generation unit.

14. The home appliance information accumulation server according to claim 13, wherein the communication unit ends communication with the home appliance when the received data is saved in the storage unit.

15. The home appliance information accumulation server according to claim 13, wherein the database generation unit performs generation or updating processing of the database asynchronously to the communication unit after the received data is saved in the storage unit.

16. The home appliance information accumulation server according to claim 13, further including a data acquisition unit configured to, in response to an external data request, extract the data from the database saved in the database saving unit and respond.
